(19) United States
(12) Patent Application Publication
(10) Pub. No.: US 2020/0350683 A1
(43) Pub. Date: Nov. 5, 2020

(54) ANTENNA DEVICE

(71) Applicant: Fraunhofer-Gesellschaft zur Foerderung der angewandten Forschung e.V., Munich (DE)

(72) Inventors: Alexander POPUGAEV, Erlangen (DE); Rainer WANSCH, Baiersdorf (DE); Mengistu TESSEMA, Nuernberg (DE)

(21) Appl. No.: 16/936,109

(22) Filed: Jul. 22, 2020

Related U.S. Application Data
(63) Continuation of application No. PCT/EP2019/052383, filed on Jan. 31, 2019.

(30) Foreign Application Priority Data
Feb. 1, 2018 (DE) 102018201575.9

(51) Int. Cl. H01Q 9/04; H01Q 1/48

(52) U.S. Cl. CPC H01Q 9/0414; H01Q 1/48

(57) ABSTRACT

An antenna device includes at least a ground plane as well as a surface emitter. The surface emitter includes a foot element and a lid element, the foot element including a base area of at least four overturned areas via which the foot element is supported with regard to the ground plane, and the lid element being coupled to the base, so that it is spaced apart from the ground plane.

### CROSS-REFERENCES TO RELATED APPLICATIONS

This application is a continuation of copending International Application No. PCT/EP2019/052383, filed Jan. 31, 2019, which is incorporated herein by reference in its entirety, and additionally claims priority from German Application No. 102018201575.9, filed Feb. 1, 2018, which is incorporated herein by reference in its entirety.

Embodiments of the present invention relate to an antenna device, a satellite antenna, as well as a method for manufacturing an antenna device. Advantageous embodiments relate to an antenna for GNSS systems.

### BACKGROUND OF THE INVENTION

Numerous applications in the fields of position sensing, measuring, and navigation by means of global navigation satellite systems (GNSS) may use antennas which allow as high a ratio of signal to noise power density (C/N0, measure for receive signal quality) as possible and have sufficient multipath rejection and as low phase center variations as possible. The technological challenge consists in finding a solution which not only meets all requirements regarding accuracy and reliability but can also be implemented in as cost-effective a manner as possible. DE 2007/004612 B4 describes an antenna concept which meets the above requirements to a certain extent (cf. [2]). In this context, reference shall be made to the conventional technology [4]. The antenna represented in FIGS. 3a and 3b, which receives all L-band signals of the four global navigation satellite systems GPS, GLONASS, Galileo, BeiDou/Compass, the frequency ranges of which are represented in FIG. 3c, and is compatible with all conventional GNSS receivers, serves as an example.

As a good compromise between effective multipath rejection and the ability to receive signals from low satellites, a 10 dB beam width of approximately 180° applies to most GNSS applications. The values achieved by means of this design range between 150° and 180° [3].

Additionally, the antenna efficiency η is of interest because it is decisive for the achievable ratio of signal to noise power density C/N0. In order to rule out all non-ideal circumstances of the four-point feeding network, a directivity D (also referred to as a directivity factor) and a gain G will be analyzed subsequently for the co-polar component (RHCP, right circular polarization) in the event of ideal amplitude and phase assignment (same amplitude and phase progression 0°, −90°, −180°, −270°) as well as of very good impedance matching of the four terminals (VSWR<1.5:1, losses due to mismatching may be neglected, e.g. <0.2 dB).

The following applies (on a linear scale):

G=ηD.

FIG. 3d shows directional diagrams (vertical section, RHCP of the GNSS antenna) according to FIG. 3a without any feeding network (ideal amplitude and phase assignment, VSWR<1.5:1). This results in a gain characterized by the solid line and in a directivity characterized by the dotted line, in dBiC. The results shown in FIG. 3d are exemplary for the highest (1.61 GHz) and the lowest (1.16 GHz) frequency of the GNSS frequency plan of FIG. 3c. Losses of approx. 2 dB, which one has not been able to reduce so far, can be noted. This is another reason why an improved approach is needed.

### SUMMARY

According to an embodiment, an antenna device may have: a ground plane; and a surface emitter which includes a foot element and a lid element, the foot element including a base area and at least four overturned areas via which the foot element is supported with regard to the ground plane, and the lid element being coupled to the base area, so that it is spaced apart from the ground plane; wherein the lid element projects beyond the foot element along the lateral extension; wherein four feeding points for the surface emitter are formed by the foot element of the surface emitter and wherein the lid element is directly placed onto the base area or is directly adjacent to the base area.

Another embodiment may have an antenna for GNSS systems for transmitting and receiving electromagnetic radiation with an inventive antenna device.

According to another embodiment, a method for manufacturing an inventive antenna device may have the steps of: providing a ground plane; overturning the overturned areas of the foot element with regard to the base area in order to shape the foot element; and disposing the lid element with regard to the ground plane by means of the foot element, so that the lid element is spaced apart with regard to the ground plane, so that the lid element is directly placed onto the base area or is directly adjacent to the base area; wherein the lid element projects beyond the foot element along the lateral extension; wherein four feeding points for the surface emitter are formed by the foot element of the surface emitter.

Embodiments of the present invention provide an antenna device with a ground plane as well as a surface emitter. The surface emitter is implemented such that it is split in two and includes a foot element and a lid element. The foot element has a base area (e.g. a planar area) and at least four overturned areas (four overturned wall areas or corners) via which the foot element is supported with regard to the ground plane. The lid element is coupled to the base area such that the lid element is spaced apart from the ground plane.

Embodiments of the present invention are based on the finding that the concept of FIGS. 3a and 3b can be further improved in terms of its efficiency by means of a surface emitter split into two when an additional lid element is provided, so that the surface emitter constitutes a “mushroom shape”, the surface emitter thus created being further characterized by wide-band adjustable radiator elements and, particularly, a simple setup, robustness, and, especially, low production costs.

According to further embodiments, the surface emitter, or, in particular, the foot of the surface emitter, are formed by a planar polygonal or planar square shape, such as, e.g., a quadrangular sheet metal in which bent corners shape the overturned areas. Assuming the planar square, or quadrangular, shape, the overturned areas are thus shaped by the (four) overturned corners. These are all reshaped in the same direction and, advantageously, also by the same degree, and have the same size, so that the base area is parallel, or substantially parallel, to the ground plane. When assuming, according to the embodiments, that the lid element (shaped by a metal sheet, for example) is connected to the base area, or is spaced apart by a predefined distance, said corresponding embodiment is also parallel to the ground plane. According to embodiments, the surface emitter comprises at least four symmetry axes which are parallel to the ground plane. According to embodiments, the lid element may also comprise a planar polygonal or planar square or also a round shape.

According to embodiments, the lid element projects beyond the base when viewed laterally. According to further embodiments, that area of the lid element which projects beyond the base area may be bent towards the ground plane or, alternatively, away therefrom. All of the variations explained above may be implemented as an initial product by means of simple polygonal or round sheet metals, generally, symmetrical sheet metals (with at least two or four symmetry axes), which shape the surface emitter by means of simple overturning and connecting. This variation may be manufactured cost-effectively and, at the same time, offers very good radiation properties, such as, e.g., a higher antenna efficiency.

According to further embodiments, the ground plane may be configured round or polygonal, with the surface emitter being disposed centrally on the ground plane according to embodiments. According to further embodiments, the antenna device may comprise a plurality of parasitic elements, such as, e.g., bars or bending parts projecting from the ground plane which are disposed around the surface emitters (for example, in a radially symmetrical or annular manner). These parasitic elements are permanently short-circuited with the electrical ground. As far as the height of these parasitic elements is concerned, it should be noted that, according to embodiments, they are taller than the surface emitter but also have, according to further embodiments, the same or a lower height as compared to the surface emitter. For example, these parasitic elements serve to perform beam-shaping.

The above embodiments explained that a quadrangular sheet metal is well-suited for shaping the foot element. The four overturned corners of the quadrangular foot element may shape the four feeding points. By doing so, a corresponding feeding network with an associated circuit and/or also with specific conductive trace routing, namely meandering conductive trace routing, may be constituted, for example, below the ground plane.

An embodiment includes a satellite antenna for receiving electromagnetic radiation, e.g. for GNSS signals.

A further embodiment includes a method for manufacturing the device explained above. This method includes three basic steps, respectively, of “providing a ground plane”, of “overturning the overturned areas of the foot element with regard to the base area in order to shape the foot element” as well as of “disposing the lid element” with regard to the ground plane by means of the foot element, so that the lid element is spaced apart with regard to the ground plane. As already explained above, these manufacturing technologies used herein are simple reshaping techniques, so that, as a result, cost-effective manufacturing can be achieved.

Further developments will be defined in the sub-claims.

### BRIEF DESCRIPTION OF THE DRAWINGS

Embodiments of the present invention will be detailed subsequently referring to the appended drawings, in which:

FIGS. 1a, 1b show three-dimensional, schematic representations of an antenna device according to embodiments with optional elements;

FIG. 1c shows schematic directional diagrams for illustrating the antenna properties of the antenna of FIGS. 1a and 1b according to embodiments;

FIG. 2 shows a schematic representation of a further antenna device according to an extended embodiment; and

FIGS. 3a-d show schematic representations for illustrating the conventional technology.

### DETAILED DESCRIPTION OF THE INVENTION

Before embodiments of the present invention will subsequently be explained in detail on the basis of the figures, it shall be noted that elements and structures having similar actions will be provided with the same reference numerals, so that their descriptions are mutually applicable, or interchangeable.

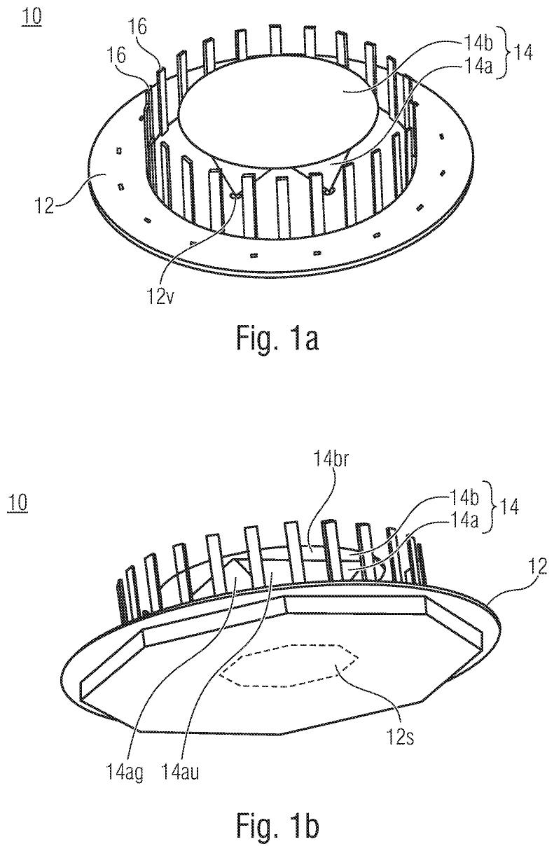

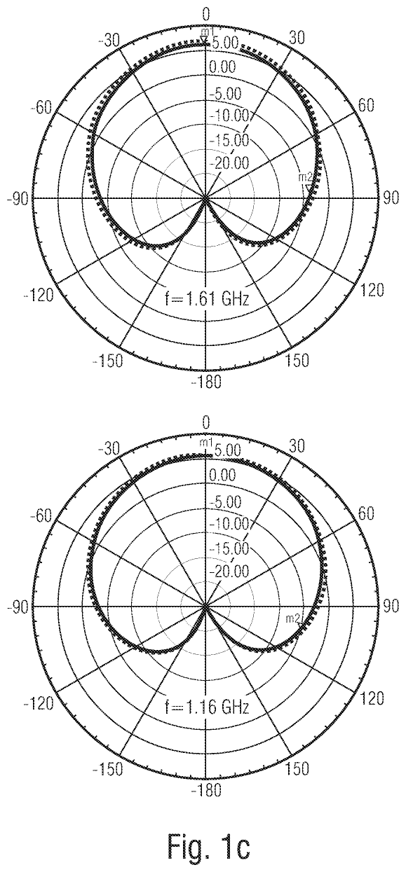

FIG. 1a shows an antenna device 10 in a three-dimensional representation from above, while FIG. 1b illustrates the same antenna device 10 in a three-dimensional representation from below.

The antenna device 10 includes a ground plane 12 as well as a surface emitter 14. Said surface emitter 14 is implemented such that it is split in two and includes the foot element 14a as well as the lid element 14b. Additionally, the antenna device 10 represented herein also comprises optional parasitic bar-shaped elements 16 which project from the ground plane 12 and surround the surface emitter 14.

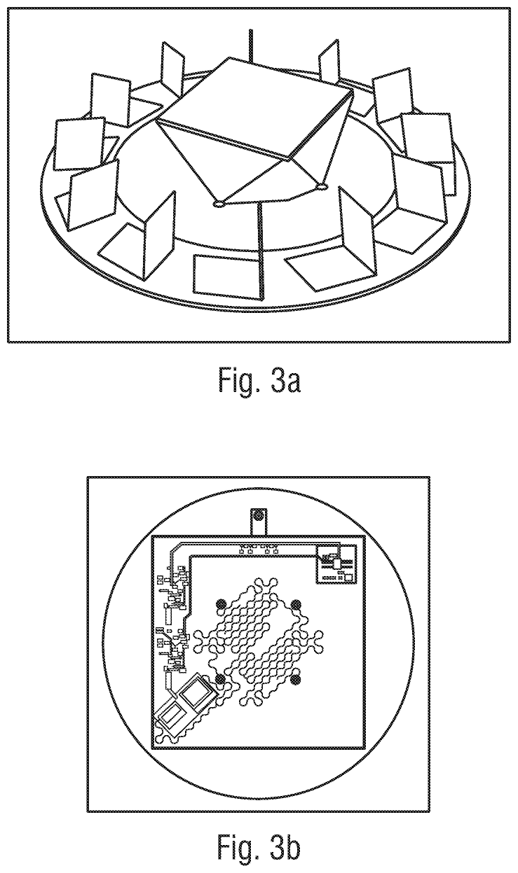

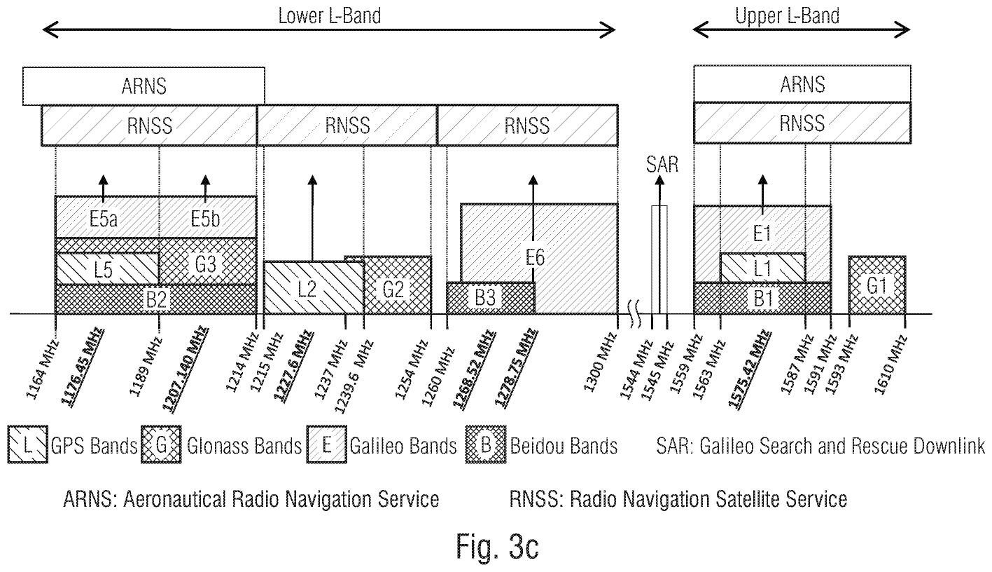

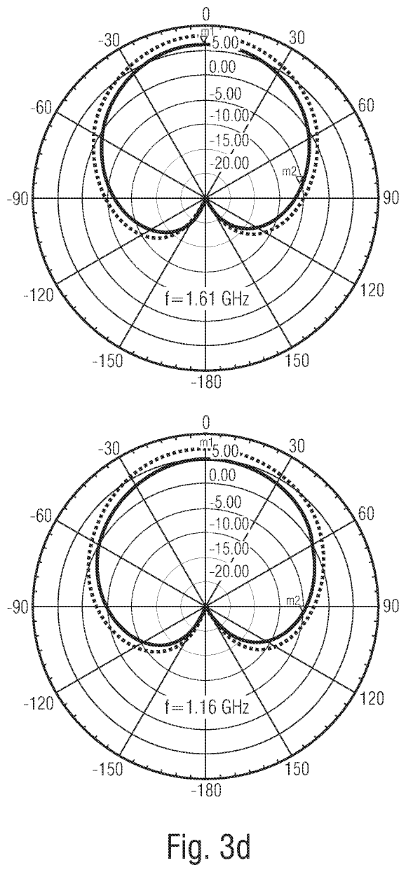

The ground plane 12 is, for example, a planar element with a round or, alternatively, polygonal (quadrangular, hexagonal, or polygonal) shape. The round or polygonally shaped ground plane 12 may optionally comprise a feeding network 12s which is disposed, e.g., on the bottom side (cf. FIG. 1b) and which is comparable to the feeding network of FIG. 3b. The ground plane is, in terms of its longitudinal extension, larger than the surface emitter 14, which, according to an embodiment, is disposed centrally. The variation represented herein is a round ground plane 12, so that the surface emitter 14 is also disposed in the area of the center.

The surface emitter 14 is implemented such that it is split in two and includes the foot element 14a and the lid element 14b. Both elements may be shaped, according to a variation, by means of sheet metals, or folded-over sheet metals. Folding-over results in two areas in the foot element 14a, namely the overturned area 14au as well as the base. In this embodiment, the foot element 14 is formed by a quadrangular sheet metal (planar square shape) in which all four corners (overturn areas 14au) are overturned in the same manner. In this context, the same manner means that both are overturned by the same angle, for example 90°, in the same direction and that the overturned triangles also have the same leg lengths. When disposing the foot element 14a on the ground plane 12 across the overturned areas 14au, the base is parallel to the ground plane 12 due to the same manifestation of the overturned areas 14au. The overturning of the areas 14au results in a quadrangular or for example also an octagonal shape for the base, depending on how large the overturned areas 14au are as compared to the base area 14ag. Due to the identical manifestation of the (four) overturned corners 14au, the three-dimensional foot element 14a has a symmetrical shape with four symmetry axes which are parallel to the base, or parallel to the ground plane 12. The base has the lid element 14b disposed on it, i.e. is either directly placed onto the former or slightly spaced apart from it, so that the distance between the lid element 14b and the ground element 12 is substantially defined by the foot element 14a. The lid element 14b may also have a polygonal, such as, for example a planar square shape, or as represented herein, a round shape. In this embodiment, the lid element 14b also projects beyond the area defined by the base 14b. As can be seen particularly in FIG. 1b, these projecting areas 14br are half-round elements. Assuming that the lid element 14b rests on the foot element or is disposed above it, it is substantially parallel to the ground plane 12. This is particularly the case when, as represented here, the lid element 14b is a flat lid element (here, a disc-shaped one).

As regards the entire surface emitter 14, which may be shaped by made of metallic sheet metal or other conductive elements and is therefore also referred to as a sheet metal radiator, it should be noted that said surface emitter 14 may, as a whole, also have at least four symmetry axes which extend within in a plane that is parallel to the ground plane 12 in a plane.

As already mentioned above, the antenna device 10 represented herein optionally comprises a plurality of electrically conductive parasitic elements 16 (e.g. bars or strips) which are disposed in a radially symmetrical manner on the ground plane 12 around the radiator. The parasitic elements 16 represented herein are, e.g., implemented by means of bending laser parts or bending stamp parts. In this embodiment, the height of these parasitic elements exceeds the height of the sheet metal radiator 14.

As compared to similar antenna devices (cf. FIG. 3a) which are also known in conventional technology, the novel antenna device 10 has a higher efficiency. Furthermore, this antenna device 10 has achieved a 10 dB beam width of approx. 180° within a larger frequency range, i.e. at least within the entire GNSS frequency range in the L-band. In this context, reference shall be made, for example, to the directional diagrams of FIG. 1c, which show a vertical section in the RHCP mode for the novel GNSS antenna 10. An ideal amplitude and phase assignment VSWR<1.5:1 is assumed. The gain is marked by means of the solid line, the directivity by means of the dotted line because all values are indicated in dBiC. Particularly the comparison to the directional diagrams of FIG. 3d suggests the improved characteristic. Thus, the novel antenna concept 10 allows higher accuracy, availability, and reliability of position sensing, particularly for geodetic applications.

According to embodiments, the feeding network 12s is electrically coupled to the surface emitter 14 via the four connection points 12v at which the foot element 14, or, to be precise, the overturned area 14a, is connected with the ground plane 12.

Before addressing extended embodiments, the manufacturing method will be described briefly. In this manufacturing method, a provided ground plane 12 which is advantageously planar is assumed, wherein a feeding substrate, or in general the antenna as explained above, may include the feeding network 12s. The foot element 14a is mounted, before or after being connected to the lid element 14b via the connection points 12, onto this ground plane, so that an additional electrically conductive element (with or advantageously without any distance) is provided, or attached, above the radiation element 14a. Attaching the lid element 14b with regard to the foot element 14a is advantageously performed such that the lid element 14b advantageously projects beyond the rim of the lower foot element 14a.

According to embodiments, the step of folding-over of the foot element 14a may also be provided before the step of attaching.

According to a further embodiment, the method includes the step of manufacturing, e.g. by bending out of the ground plane 12, or, generally, of disposing, a plurality of electrically conductive parasitic elements, e.g. eight or more. Disposing is performed such that they are galvanically connected to the ground plane 12.

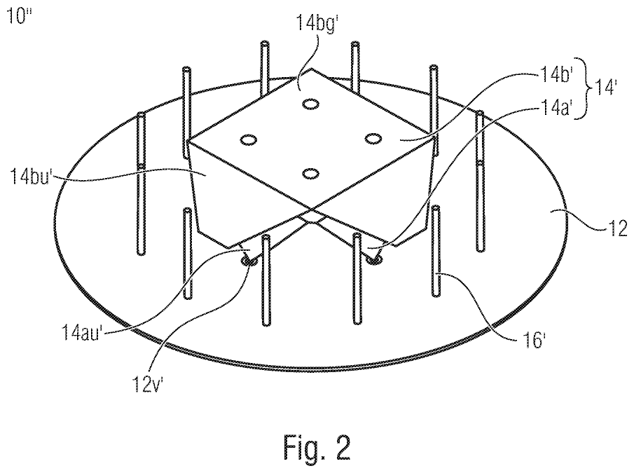

Subsequently, a further embodiment will be explained with reference to FIG. 2.

FIG. 2 shows an antenna device 10′ with a ground plane 12, which is also implemented to be round here, and a surface emitter 14′ disposed centrally on the ground plane 12. Said surface emitter 14′ includes the foot element 14a′ as well as the lid element 14b′. The foot element 14a′ is comparable to the foot element 14a and is also connected via the four overturned corners 14au′ at the connection points of the ground plane 12, which connection points are designated by reference numeral 12v′. The lid element 14b′ is shaped, in this embodiment, as a polygonal element because the protruding areas 14bu′ are bent towards the ground plane 12. The four protruding areas 14bu′ have a trapezoidal shape and are bent towards the ground plane 12 by approx. 45°, and at this point, it should be noted that other angles, such as, e.g., 5°, 10°, 25°, or, generally, within the range of 5-75° or 1-89°, would also be feasible. Also, it is not imperative that the bent elements 14bu′ have a trapezoidal shape in a bent lid 14b′. Semicircular or triangular or rectangular elements would also be feasible. In this embodiment, the base 14bg′ of the lid 14b′ rests on the base of the foot element 14a′ such that the base 14bg′ as well as the base of the foot 14a′ constitute the same shape, herein a rectangular shape. The bending edges for the bendable areas 14bu′ are, according to embodiments, substantially parallel to, or even substantially congruent with, the bending edges of the foot element 14a′ between the base and the overturned area 14au′.

In this embodiment, the parasitic elements are not formed as stamp-bent or laser-bent elements but by parasitic elements projecting in a perpendicular manner, herein perpendicular bars 16′ (for example, 12′).

These embodiments are characterized by being able to be manufactured in a simple, mechanically stable and cost-efficient way and are much more efficient as compared to similar devices known from the conventional technology. Furthermore, they have a better form of directivity pattern for GNSS applications (cardioid-shaped, 10 dB beam width approx. 180°).

The technical field of application of the invention corresponds to that of the antenna device in [2] and thus includes position sensing and measurement in agriculture and forestry, cadastral surveys, vehicle and machine controls in the construction industry and in agriculture, GNSS monitoring systems, Galileo PRS, aerospace applications, or on- and offshore navigation.

Regarding the above-mentioned embodiments, it should be noted that each of the planar shape of the ground plane, the basic shape of the foot element and the basic shape of the lid element may vary according to further embodiments, wherein these three elements may act in the same way or also differently (i.e. the combination of a circular shape with a polygonal shape such as a quadrangular shape with a round sheet metal as initial elements).

In the above-mentioned embodiments, it was essentially assumed that all of the overturned areas are areas that are overturned by 90°. Also, these overturned areas may vary.

Even if in the above embodiments it was assumed that each of the overturned areas of the foot elements comprises a tip via which coupling to the ground element is performed, it should be noted at this point that other shapes would also be possible.

In the above embodiments, substantially, the device was explained, and herein particularly the antenna device. A further embodiment relates to a system with a feeding network and an antenna device. An additional embodiment relates to using the antenna device as a satellite transceiver unit.

A further embodiment relates to a manufacturing method, wherein it should be noted at this point that descriptions of elements or components also represent a corresponding description of the associated method step.

The above embodiments are substantially merely illustrative, with a scope of protection being defined for the subsequent claims.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] K. Fletcher (ed.), “GNSS Data Processing, Vol. I: Fundamentals and Algorithms”, ESA Communications, ESA TM-23/1, May 2013
[2] DE 10 2007 004 612 B4
[3] A. E. Popugaev, R. Wansch, “Multi-band GNSS antenna” in: Heuberger, A; Elst, G; Hanke, R. (editor): Microelectronic Systems: Circuits, Systems and Applications, Springer Verlag, 2011
[4] U.S. Pat. No. 5,442,366 A

1. Antenna device, comprising
a ground plane; and
a surface emitter which comprises a foot element and a lid element, the foot element comprising a base area and at least four overturned areas via which the foot element is supported with regard to the ground plane, and the lid element being coupled to the base area, so that it is spaced apart from the ground plane;
wherein the lid element projects beyond the foot element along the lateral extension;
wherein four feeding points for the surface emitter are formed by the foot element of the surface emitter and wherein the lid element is directly placed onto the base area or is directly adjacent to the base area.

2. Antenna device according to claim 1, wherein the foot element of the surface emitter is formed by a planar polygonal shape or a planar square shape, and the overturned areas are formed by corners of the planar polygonal shape or the planar square shape.

3. Antenna device according to claim 1, wherein the surface emitter comprises at least four symmetry axes which are parallel to the ground plane.

4. Antenna device according to claim 1, wherein the lid element is formed by a sheet metal which is parallel to the ground plane.

5. Antenna device according to claim 1, wherein the lid element is bent towards the ground plane in that area in which it projects beyond the foot element.

6. Antenna device according to claim 1, wherein the lid element is bent away from the ground plane in that area in which it projects beyond the foot element.

7. Antenna element according to claim 5, wherein the lid element comprises a planar polygonal shape or a planar square shape, and edges of the planar polygonal shape or the planar square shape are bent towards the ground plane.

8. Antenna device according to claim 1, wherein the lid element comprises a round shape.

9. Antenna device according to claim 1, wherein the ground plane comprises a round or polygonal shape.

10. Antenna device according to claim 1, wherein the surface emitter and/or the lid element of the surface emitter is centered with regard to the ground plane.

11. Antenna device according to claim 1, which comprises a plurality of parasitic elements which are disposed around the surface emitter and are permanently short-circuited with the electrical ground plane.

12. Antenna device according to claim 11, wherein the parasitic elements surround the surface emitter in a radially symmetrical and/or annular manner.

13. Antenna device according to claim 12, wherein the parasitic elements project from the ground plane by more than the lid element is spaced apart from the ground plane.

14. Antenna device according to claim 12, wherein the parasitic elements project from the ground plane as much, as a maximum, as the lid element is spaced apart from the ground plane.

15. Antenna device according to claim 13, wherein the parasitic elements are shaped by bars or bending parts.

16. Antenna for GNSS systems for transmitting and receiving electromagnetic radiation with an antenna device, said antenna device comprising:
a ground plane; and
a surface emitter which comprises a foot element and a lid element, the foot element comprising a base area and at least four overturned areas via which the foot element is supported with regard to the ground plane, and the lid
element being coupled to the base area, so that it is spaced apart from the ground plane;
wherein the lid element projects beyond the foot element along the lateral extension; wherein four feeding points for the surface emitter are formed by the foot element of the surface emitter and wherein the lid element is directly placed onto the base area or is directly adjacent to the base area.

17. Method for manufacturing an antenna device according to claim 1, comprising
providing a ground plane;
overturning the overturned areas of the foot element with regard to the base area in order to shape the foot element; and
disposing the lid element with regard to the ground plane by means of the foot element, so that the lid element is spaced apart with regard to the ground plane, so that the lid element is directly placed onto the base area or is directly adjacent to the base area;
wherein the lid element projects beyond the foot element along the lateral extension;
wherein four feeding points for the surface emitter are formed by the foot element of the surface emitter.
